(19) United States
(12) Patent Application Publication
(10) Pub. No.: US 2026/0326755 A1
(43) Pub. Date: Oct. 22, 2026

(54) COLLISION MITIGATION

(71) Applicant: HONDA MOTOR CO., LTD., Tokyo (JP)

(72) Inventors: Minjun SUNG, Savoy, IL (US); Sangjae BAE, Mountain View, CA (US); Jovin D'SA, San Jose, CA (US); David Francis ISELE, Sunnyvale, CA (US); Faizan M. TARIQ, San Jose, CA (US)

(21) Appl. No.: 19/374,869

(22) Filed: Oct. 30, 2025

Related U.S. Application Data
(60) Provisional application No. 63/792,461, filed on Apr. 22, 2025.

(51) Int. Cl. B60W 30/095; B60W 10/04; B60W 10/18; B60W 10/20; B60W 40/02; G08G 1/16

(52) U.S. Cl. CPC B60W 30/0956; B60W 10/04; B60W 10/18; B60W 10/20; B60W 40/02; G08G 1/16; B60W 2540/227; B60W 2710/18; B60W 2710/20; B60W 2720/106

(57) ABSTRACT

According to one aspect, collision mitigation may include calculating a probability of collision metric associated with a potential collision between an agent and an obstacle in an operating environment based on one or more scene inputs, calculating a collision severity metric associated with the potential collision based on the one or more scene inputs, calculating a composite risk based on the probability of collision metric and the collision severity metric, and controlling the agent to perform an operating action based on the composite risk. The probability of collision metric may be determined based on a time to collision (TTC) between the agent and the obstacle or a time to closest encounter (TTCE) between the agent and the obstacle. The calculating the composite risk may be based on a seating configuration associated with the agent.

### CROSS-REFERENCE TO RELATED APPLICATIONS

This application claims the benefit of U.S. Provisional Patent Application, Ser. No. 63/792,461 entitled “CRASH MITIGATION”, filed on Apr. 22, 2025; the entirety of the above-noted application(s) is incorporated by reference herein.

### BACKGROUND

Modern vehicles may use collision mitigation systems, which combine radar, cameras, and sensors to detect potential hazards, alert drivers, or apply brakes automatically in an unavoidable collision. Generally, mitigation may include taking steps to lessen the impact of damages and injuries after an incident has occurred or to prevent or reduce the severity of an imminent crash. For example, mitigation may include using technologies such as Automatic Emergency Braking (AEB) to prevent or lessen the impact of crashes.

### BRIEF DESCRIPTION

According to one aspect, a system for collision mitigation may include a processor and a memory. The memory may store one or more instructions. The processor may execute one or more of the instructions stored on the memory to perform one or more acts, actions, and/or steps. The processor may perform calculating a composite risk associated with a potential collision between an agent and an obstacle in an operating environment based on a probability of collision metric and a collision severity metric and controlling the agent to perform an operating action based on the composite risk.

The probability of collision metric may be determined based on a time to collision (TTC) between the agent and the obstacle. The probability of collision metric may be determined based on a time to closest encounter (TTCE) between the agent and the obstacle. The processor may calculate the probability of collision metric based on one or more scene inputs including one or more of sensor data or scene metadata. The processor may calculate the collision severity metric based on one or more scene inputs including one or more of agent metadata, sensor data, or scene metadata. The processor may calculate the composite risk based on a seating configuration associated with the agent and control the agent to perform the operating action based on the composite risk and the seating configuration. The composite risk may be from a perspective of the agent. The obstacle may be a second agent. The processor may calculate a second composite risk associated with the potential collision between the agent and the obstacle based on the probability of collision metric and the collision severity metric from a perspective of the second agent. The processor may control the agent to perform the operating action based on the composite risk and the second composite risk. The operating action may be a steering action, a braking action, or an acceleration action.

According to one aspect, a system for collision mitigation may include a processor and a memory. The memory may store one or more instructions. The processor may execute one or more of the instructions stored on the memory to perform one or more acts, actions, and/or steps. The processor may perform calculating a composite risk associated with a potential collision between an agent and an obstacle in an operating environment based on a probability of collision metric and a collision severity metric and rendering a warning for the agent based on the composite risk.

The probability of collision metric may be determined based on a time to collision (TTC) between the agent and the obstacle. The probability of collision metric may be determined based on a time to closest encounter (TTCE) between the agent and the obstacle. The processor may calculate the probability of collision metric based on one or more scene inputs including one or more of sensor data or scene metadata. The processor may calculate the collision severity metric based on one or more scene inputs including one or more of agent metadata, sensor data, or scene metadata.

According to one aspect, a computer-implemented method for collision mitigation may include calculating a probability of collision metric associated with a potential collision between an agent and an obstacle in an operating environment based on one or more scene inputs, calculating a collision severity metric associated with the potential collision based on the one or more scene inputs, calculating a composite risk based on the probability of collision metric and the collision severity metric, and controlling the agent to perform an operating action based on the composite risk.

The probability of collision metric may be determined based on a time to collision (TTC) between the agent and the obstacle. The probability of collision metric may be determined based on a time to closest encounter (TTCE) between the agent and the obstacle. The calculating the composite risk may be based on a seating configuration associated with the agent. The operating action may be a steering action, a braking action, or an acceleration action.

### BRIEF DESCRIPTION OF THE DRAWINGS

FIG. 1 is an exemplary component diagram of a system for collision mitigation, according to one aspect.

FIG. 2 is an exemplary flow diagram of a computer-implemented method for collision mitigation, according to one aspect.

FIG. 3 is an exemplary illustration of an architecture associated with the system for collision mitigation of FIG. 1, according to one aspect.

FIG. 4 is an exemplary scenario in associated with collision mitigation, according to one aspect.

FIG. 5 is an illustration of an example computing environment where one or more of the provisions set forth herein are implemented, according to one aspect.

FIG. 6 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “controller”, as used herein, may be a device implemented in hardware, firmware, software, or a combination thereof. A controller may include one or more CPUs (e.g., a central processing unit including one or more “processors”), a “memory”, a “storage drive”, a “bus”, and one or more programmable input/output (I/O) peripherals.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

An “agent”, as used herein, may be a machine that moves through or manipulates an environment. Exemplary agents may include robots, vehicles, other vehicles, or other self-propelled machines. The agent may be autonomously, semi-autonomously, or manually operated.

While the majority of existing motion planning frameworks emphasize collision avoidance, they often fail to account for qualitative differences in collision configurations, such as the location of the impact. These factors may influence the severity associated with collision to occupants. Conventional approaches typically assume that avoiding a collision may be desired. However, this assumption breaks down in scenarios where a collision is inevitable due to time or space constraints. In such cases, the objective should smoothly shift from avoidance to mitigation. For example, actively choosing a collision configuration that minimizes harm to passengers. For instance, steering toward the front or rear of the vehicle, rather than exposing the passenger-side door to impact, to mitigate collision damage. Furthermore, naively attempting to avoid a collision, such as by accelerating just before a head-on impact may intensify the collision severity. This highlights the need for a motion planning system that explicitly considers collision mitigation, rather than relying solely on avoidance strategies.

The systems and methods described herein address this challenge by introducing a unified risk-aware motion planning framework that integrates learned risk estimation into predictive control. One advantage or benefit provided is a composite risk function learned from a real-world pre-collision dataset. The probability of collision is modeled as a function of time-to-collision (TTC), while severity may be estimated via physically grounded metrics such as expected impact force under a fully inelastic collision assumption. Moreover, the passenger configuration and the impact location may also be considered. This composite function enables the planner to evaluate not only how likely a collision is, but also how much risk is associated with the collision, shifting the focus from merely avoiding collisions to intelligently minimizing their impact when they cannot be avoided.

Unlike prior approaches that require explicit switching between collision avoidance and mitigation modes, this framework naturally unifies both behaviors through continuous risk optimization. The planner continuously evaluates risk across the trajectory space and selects control actions that inherently balance avoidance and mitigation without predefined heuristics or transitions.

This framework also introduces the ability to reason about passenger configurations, making it possible to prioritize avoidance of impact zones proximate to passengers (e.g., avoiding collisions on the side of the vehicle with seated passengers). The risk model is integrated into real-time trajectory generation using predictive control, enabling safe and interpretable behavior planning in complex environments.

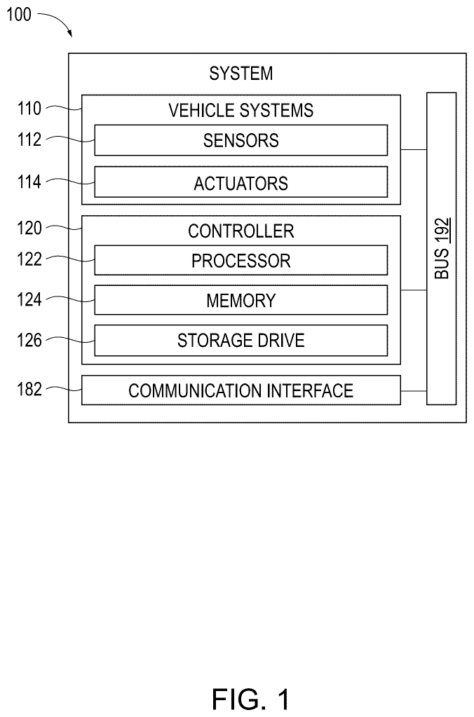

FIG. 1 is an exemplary component diagram of a system 100 for collision mitigation, according to one aspect. The system 100 for collision mitigation may be implemented on a vehicle and include one or more vehicle systems 110. The vehicle systems 110 may include one or more sensors 112 and one or more actuators 114. The system 100 for collision mitigation may include a controller 120. The controller 120 may include a processor 122, a memory 124, and a storage drive 126. The system 100 for collision mitigation may include a communication interface 182 and a bus 192. The bus 192 may form an operable connection between respective components of the system 100 for collision mitigation (e.g., the vehicle systems 110, the controller 120, the communication interface 182, etc.) and enable computer communication therebetween. According to another aspect, the system 100 for collision mitigation may be implemented on a mobile device, such as a dashboard camera (dashcam), or Advanced Driver Assistance Systems (ADAS) dashcam. In these implementations, the system 100 for collision mitigation may not include the vehicle systems 110, but may instead access any corresponding information via the communication interface 182. For example, the communication interface 182 may receive sensor data from the sensors 112 of the vehicle and transmit any outputs, such as the composite risk to the vehicle. In any event, the features or calculations performed by the processor 122 described herein may be distributed between any number of mobile devices, systems, sub-systems, etc.

The sensors 112 may receive one or more scene inputs including sensor data or scene metadata, such as sensor data from radar sensors 112 or Light Detection and Ranging (LiDAR), sensor data from image capture devices mounted to the vehicle indicative of the position, velocity, etc. of any objects or obstacles around the agent. Additionally, the scene metadata (e.g., maps data or global positioning system (GPS) data) may be received via the communication interface 182 from an external server.

The storage drive 126 may store the scene inputs as well as models associated with the composite risk prediction, the collision severity prediction, and the probability of collision prediction, such as a composite risk model that may generate a composite risk based on one or more scene embeddings from one or more of the scene inputs. The composite risk model may be trained based on a composite risk function that models both collision likelihood and severity using a real-world collision dataset, enabling nuanced evaluation of potential threats.

According to one example, the real-world collision dataset may include pre-collision data between two vehicles, including a series of timestamps, coordinates, associated angles, bearings, headings, lengths, widths, heights, weights, etc. for each vehicle. Additionally, force, a collision tag, etc. may be calculated or provided. It may be assumed that the estimated collision duration is

$$Δ t = \frac{1}{relative velocity} ,$$

force is equally applied to both sides as

$$F = \frac{m * Δ v}{Δ t} .$$

Collision severity may be calculated using a G-force or Delta-v calculation, and damage may be quadratically proportional to acceleration, where F=m*a and

$${G}_{i} = \frac{{F}_{i}}{{m}_{i}} .$$

The impact location may be annotated as well (e.g., left, right, front, back, or using different zones). The centroid of the intersected geometry may be calculated, the global angle computed as

$${θ}_{global} = {tan}^{- 1} ( \frac{{y}_{collision} - {y}_{vehicle}}{{x}_{collision} - {x}_{vehicle}} ) ,$$

with x and y being vehicle coordinates. The relative θ with regard to the vehicle heading angle may be computed as θᵣₑₗₐₜᵢᵥₑ=(θ_{global}−ψ)mod 360. Further, the vehicle heading angle may be partitioned or binned into different categories by groups of angles (e.g., 0-15 degrees, 16-30 degrees, etc.).

The memory 124 may store one or more instructions. The processor 122 may execute one or more of the instructions stored on the memory 124 to perform one or more acts, actions, and/or steps.

For example, the processor 122 may calculate a probability of collision metric (e.g., the probability of collision prediction) associated with a potential collision between an agent (e.g., ego-agent or ego-vehicle) and an obstacle in an operating environment based on one or more scene inputs including one or more of sensor data or scene metadata. The obstacle may be an object, a static object, a dynamic or moving object, such as another agent or a second agent, for example. Examples of agents may include pedestrians, other vehicles, motorcycles and motorcyclists, bicycles and bicyclists, etc. Scene inputs may include the sensor data from the sensors 112, agent metadata (e.g., the weight of the agent vehicle), or scene metadata (e.g., map data, global positioning system (GPS) data, etc.).

The probability of collision metric may represent a probability that a collision may occur between the agent and the obstacle. According to one aspect, the probability of collision metric may be determined based on a time to collision (TTC) between the agent and the obstacle or based on a time to closest encounter (TTCE) between the agent and the obstacle. Because TTC is a one-dimensional metric, TTC may be defined as an exponential function with TTCE to scale the probability of collision. It will be appreciated that TTC is merely one example to quantify the probability of collision, and other variants (e.g., distance risk) may be implemented. According to one aspect, the processor 122 may compute TTC based on state predictions, (e.g., the closest time step when the predicted states of the two or more vehicles intersect). For example, a constant velocity assumption is utilized, the processor 122 may forward-propagate the vehicles over the prediction horizon and detect if any collisions exist, and if it exists, use the earliest time step of collision to estimate the TTC. For example, the probability of collision, P=e^{-TTC}.

Additionally, the processor 122 may calculate a collision severity metric (e.g., collision severity prediction) associated with the potential collision based on the one or more scene inputs including one or more of agent metadata, sensor data, or scene metadata. The collision severity metric may represent an estimated severity of a collision if or when the collision occurs. According to one aspect, the collision severity metrics S=G²*ORFS.

Based on the above, the processor 122 may calculate a composite risk (e.g., composite risk prediction) based on the probability of collision metric and the collision severity metric. According to one aspect, the processor 122 may calculate the composite risk based on a seating configuration associated with the agent and control the agent to perform the operating action based on the composite risk and the seating configuration. In this way, the seating configuration may be utilized to mitigate any damage from the potential or impending collision. In this way, the composite risk may be calculated from a perspective of the agent.

The seating configuration information may be obtained from the sensors 112 of the system 100 for collision mitigation (e.g., pressure sensors 112 embedded in seats in the vehicle, etc.). For example, when a driver is the only occupant within the vehicle and thus, occupying the driver-side of the vehicle, the controller 120 may control the actuators 114 to steer the vehicle or agent such that the passenger side of the vehicle absorbs any impact associated with the potential or impending collision. According to one aspect, a passenger-aware planner, implemented via the processor 122, may account for the seating configuration of occupants, allowing the system 100 for collision mitigation to steer away from impact zones proximate to passengers. In this way, a control strategy that enables intelligent configuration of inevitable collisions to reduce harm to passengers or occupants, addressing a gap in existing systems may be provided.

According to one aspect, the system 100 for collision mitigation may be implemented on a vehicle such as a motorcycle. Here, the seating confirmation may not necessarily be utilized during calculation of the composite risk. However, other inputs, such as agent metadata may be utilized, such as a model of the motorcycle, a weight of the motorcycle, or other specifications of associated with the vehicle or agent.

According to one aspect, the processor 122 may calculate a second composite risk associated with the potential collision between the agent and the obstacle based on the probability of collision metric and the collision severity metric from a perspective of the second agent. According to this aspect, the processor 122 may control the agent to perform the operating action based on the composite risk and the second composite risk.

The processor 122 may control the agent to perform an operating action based on the composite risk. One way of achieving this may be to pass the composite risk through an optimal controller. The optimal controller may then generate an optimal course of action for the agent based on the composite risk. For example, the processor 122 or the controller 120 may control the actuators 114 to perform the operating action including one of a steering action, a braking action, or an acceleration action to facilitate the collision mitigation, even when the crash or collision is imminent. In this way, any damage associated with the potential collision may be mitigated.

According to another aspect, the processor 122 may render a warning for the agent based on the composite risk using one or more of the vehicle systems 110, which may include a display, a speaker, a dashboard, etc. In this way, a mode-free integration of collision avoidance and crash mitigation that requires no explicit switching mechanism may be provided, ensuring smooth and interpretable decision-making even under rapidly evolving scenarios.

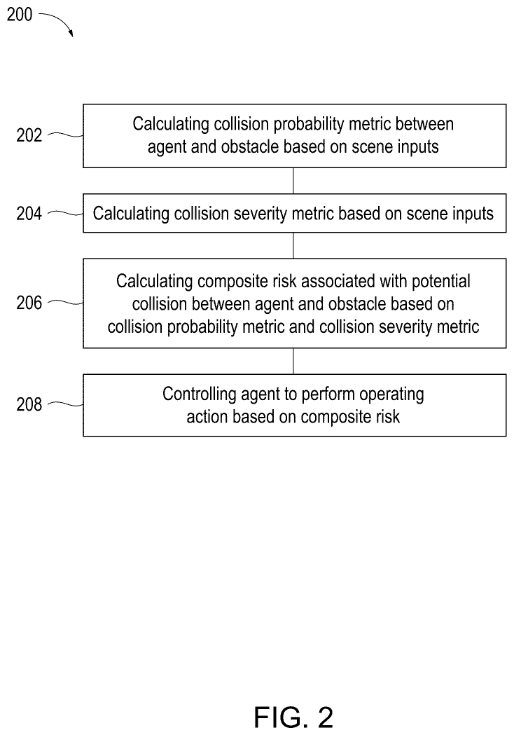

FIG. 2 is an exemplary flow diagram of a computer-implemented method 200 for collision mitigation, according to one aspect. The computer-implemented method 200 for collision mitigation may include calculating 202 a probability of collision metric associated with a potential collision between an agent and an obstacle in an operating environment based on one or more scene inputs, calculating 204 a collision severity metric associated with the potential collision based on the one or more scene inputs, calculating 206 a composite risk based on the probability of collision metric and the collision severity metric, and controlling 208 the agent to perform an operating action based on the composite risk. The probability of collision metric may be determined based on a time to collision (TTC) between the agent and the obstacle or based on a time to closest encounter (TTCE) between the agent and the obstacle. Further, the calculating the composite risk may be based on a seating configuration associated with the agent.

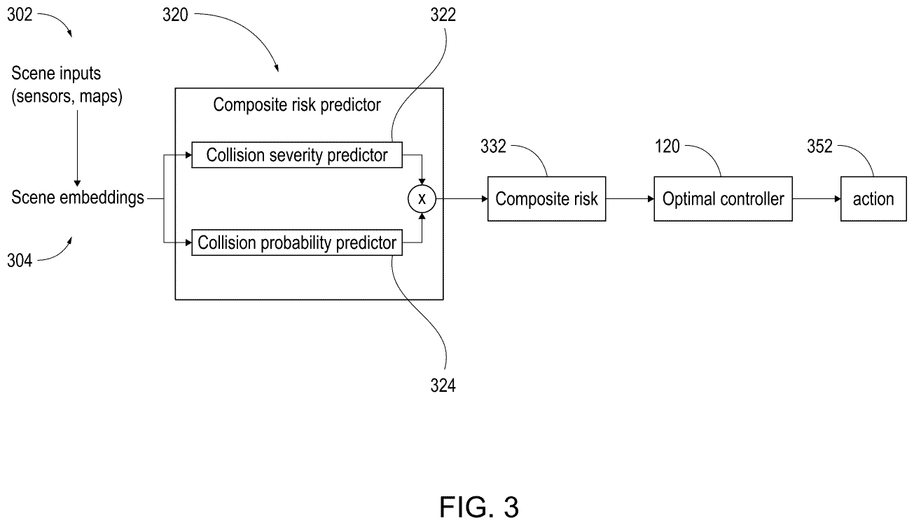

FIG. 3 is an exemplary illustration of an architecture associated with the system for collision mitigation of FIG. 1, according to one aspect. As seen in FIG. 3, the scene inputs 302 may be sensed or detected by sensors or received from external sources, and the processor may generate one or more scene embeddings 304 based on the scene inputs 302. The processor may process raw scene inputs to compute the scene embeddings, which may be preprocessed to compute the probability of collision metric and the collision severity metric. The composite risk predictor 320 may include a collision severity predictor 322 and a probability of collision predictor 324. The collision severity predictor 322 may generate a collision severity metric while the probability of collision predictor 324 may generate a probability of collision metric. As discussed herein, this probability of collision metric may be based on TTC and/or TTCE. The composite risk predictor 320, using the processor, may calculate a composite risk 332 or composite risk prediction based on the probability of collision metric and the collision severity metric. According to one aspect, the composite risk 332 may be computed as a product of the collision severity metric and the probability of collision metric. The optimal controller (e.g., the controller) may generate the operating action 352 based on the composite risk 332. Further, computation timing may be reduced by making the composite risk predictor 320 a single neural network model inference.

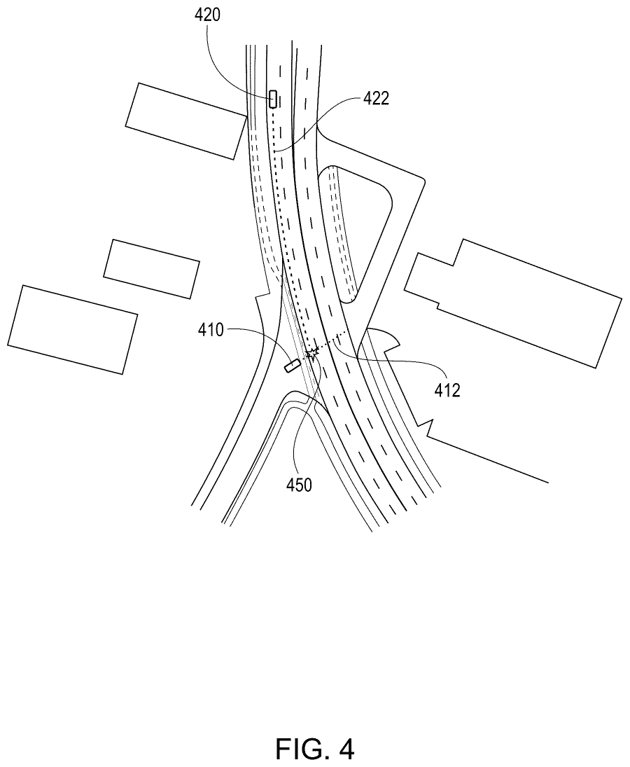

FIG. 4 is an exemplary scenario in associated with collision mitigation, according to one aspect. A first agent 410 (e.g., first vehicle) may be travelling along a first path 412 or route and a second agent 420 (e.g., second vehicle) may be travelling along a second path 422 or route. An impending collision 450 may occur or be imminent. The occupant of the first vehicle may be on a driver-side or left side of the vehicle. Seating configuration information obtained from the sensors of the system for collision mitigation (e.g., pressure sensors embedded in seats in the vehicle, etc.) may alert the system for collision mitigation that the collision will occur on the driver-side of the first vehicle. In this scenario, if the driver is the only occupant within the vehicle and occupying the driver-side of the vehicle, and the composite risk is calculated indicating that the driver may be on a side of the vehicle near the impact, the controller may control the actuators to steer the first vehicle such that the passenger side of the vehicle (e.g., via a left turn steering operation) or the rear of the first vehicle (e.g., via a right turn steering operation) absorbs any impact associated with the potential or impending collision.

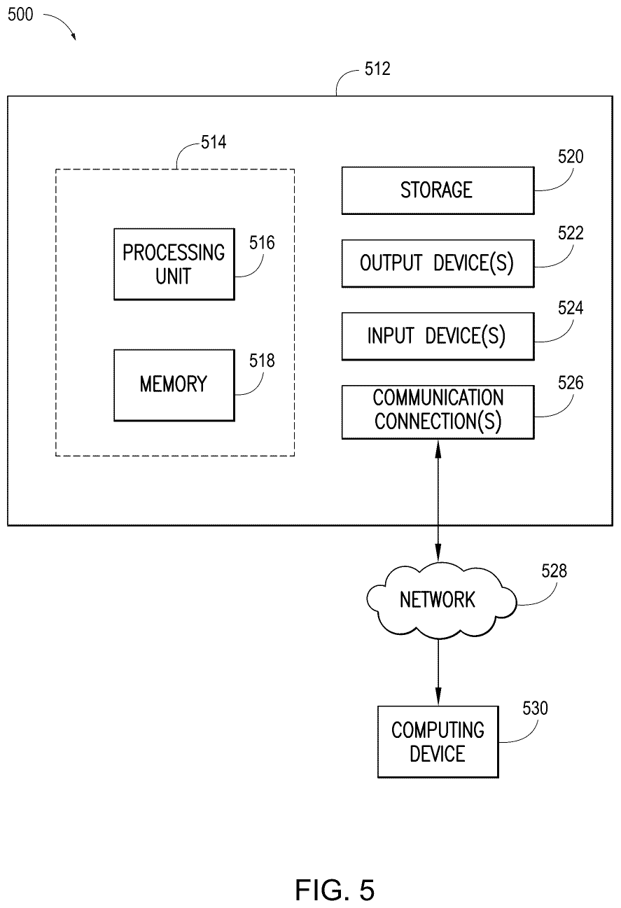

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini-computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 5 illustrates a system 500 including a computing device 512 configured to implement one aspect provided herein. In one configuration, the computing device 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other aspects, the computing device 512 includes additional features or functionality. For example, the computing device 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by the at least one processing unit 516, for example.

The term “computer readable media” as used herein includes computer storage media. Computer storage media includes volatile and nonvolatile, removable, and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 512. Any such computer storage media is part of the computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with the computing device 512. Input device(s) 524 and output device(s) 522 may be connected to the computing device 512 via a wired connection, wireless connection, or any combination thereof. In one aspect, an input device or an output device from another computing device may be used as input device(s) 524 or output device(s) 522 for the computing device 512. The computing device 512 may include communication connection(s) 526 to facilitate communications with one or more other devices 530, such as through network 528, for example.

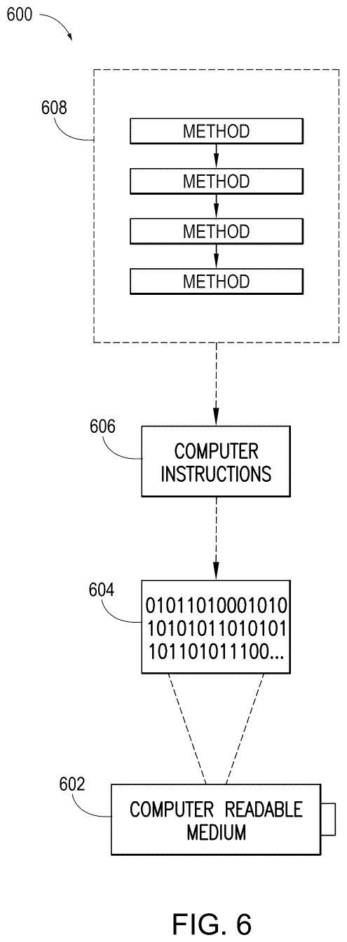

Still another aspect involves a computer-readable medium including processor-executable instructions configured to implement one aspect of the techniques presented herein. An aspect of a computer-readable medium or a computer-readable device devised in these ways is illustrated in FIG. 6, where an implementation 600 includes a computer-readable medium 602, such as a CD-R, DVD-R, flash drive, a platter of a hard disk drive, etc., on which is encoded computer-readable data 604. This encoded computer-readable data 604, such as binary data including a plurality of zero's and one's as shown in 604, in turn includes a set of processor-executable computer instructions 606 configured to operate according to one or more of the principles set forth herein. In this implementation 600, the processor-executable computer instructions 606 may be configured to perform a method 608, such as the computer-implemented method 200 for collision mitigation of FIG. 2. In another aspect, the processor-executable computer instructions 606 may be configured to implement a system, such as the system 100 for collision mitigation of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for collision mitigation, comprising:
a memory storing one or more instructions; and
a processor executing one or more of the instructions stored on the memory to perform:
calculating a composite risk associated with a potential collision between an agent and an obstacle in an operating environment based on a probability of collision metric and a collision severity metric; and
controlling the agent to perform an operating action based on the composite risk.

2. The system for collision mitigation of claim 1, wherein the probability of collision metric is determined based on a time to collision (TTC) between the agent and the obstacle.

3. The system for collision mitigation of claim 1, wherein the probability of collision metric is determined based on a time to closest encounter (TTCE) between the agent and the obstacle.

4. The system for collision mitigation of claim 1, wherein the processor calculates the probability of collision metric based on one or more scene inputs including one or more of sensor data or scene metadata.

5. The system for collision mitigation of claim 1, wherein the processor calculates the collision severity metric based on one or more scene inputs including one or more of agent metadata, sensor data, or scene metadata.

6. The system for collision mitigation of claim 1, wherein the processor calculates the composite risk based on a seating configuration associated with the agent and controls the agent to perform the operating action based on the composite risk and the seating configuration.

7. The system for collision mitigation of claim 1, wherein the composite risk is from a perspective of the agent.

8. The system for collision mitigation of claim 1, wherein the obstacle is a second agent and wherein the processor calculates a second composite risk associated with the potential collision between the agent and the obstacle based on the probability of collision metric and the collision severity metric from a perspective of the second agent.

9. The system for collision mitigation of claim 8, wherein the processor controls the agent to perform the operating action based on the composite risk and the second composite risk.

10. The system for collision mitigation of claim 1, wherein the operating action is a steering action, a braking action, or an acceleration action.

11. A system for collision mitigation, comprising:
a memory storing one or more instructions; and
a processor executing one or more of the instructions stored on the memory to perform:
calculating a composite risk associated with a potential collision between an agent and an obstacle in an operating environment based on a probability of collision metric and a collision severity metric; and
rendering a warning for the agent based on the composite risk.

12. The system for collision mitigation of claim 11, wherein the probability of collision metric is determined based on a time to collision (TTC) between the agent and the obstacle.

13. The system for collision mitigation of claim 11, wherein the probability of collision metric is determined based on a time to closest encounter (TTCE) between the agent and the obstacle.

14. The system for collision mitigation of claim 11, wherein the processor calculates the probability of collision metric based on one or more scene inputs including one or more of sensor data or scene metadata.

15. The system for collision mitigation of claim 11, wherein the processor calculates the collision severity metric based on one or more scene inputs including one or more of agent metadata, sensor data, or scene metadata.

16. A computer-implemented method for collision mitigation, comprising:
calculating a probability of collision metric associated with a potential collision between an agent and an obstacle in an operating environment based on one or more scene inputs;
calculating a collision severity metric associated with the potential collision based on the one or more scene inputs;
calculating a composite risk based on the probability of collision metric and the collision severity metric; and
controlling the agent to perform an operating action based on the composite risk.

17. The computer-implemented method for collision mitigation of claim 16, wherein the probability of collision metric is determined based on a time to collision (TTC) between the agent and the obstacle.

18. The computer-implemented method for collision mitigation of claim 16, wherein the probability of collision metric is determined based on a time to closest encounter (TTCE) between the agent and the obstacle.

19. The computer-implemented method for collision mitigation of claim 16, wherein the calculating the composite risk is based on a seating configuration associated with the agent.

20. The computer-implemented method for collision mitigation of claim 16, wherein the operating action is a steering action, a braking action, or an acceleration action.
